(19) United States
(12) Patent Application Publication
(10) Pub. No.: US 2023/0377188 A1
(43) Pub. Date: Nov. 23, 2023

(54) GROUP SPECIFICATION APPARATUS, GROUP SPECIFICATION METHOD, AND COMPUTER-READABLE RECORDING MEDIUM

(71) Applicant: NEC Corporation, Minato-ku, Tokyo (JP)

(72) Inventor: Hiroo IKEDA, Tokyo (JP)

(73) Assignee: NEC Corporation, Minato-ku, Tokyo (JP)

(21) Appl. No.: 18/030,909

(22) PCT Filed: Oct. 14, 2020
(86) PCT No.: PCT/JP2020/038817

§ 371 Date: Apr. 7, 2023

(51) Int. Cl. G06T 7/70; G06T 7/62; G06V 10/25; G06V 10/74; G06V 20/70

(52) U.S. Cl. CPC G06T 7/70; G06T 7/62; G06V 10/25; G06V 10/761; G06V 20/70; G06V 2201/07; G06T 2207/30196; G06T 2207/30242

(57) ABSTRACT

A group specification apparatus includes: a first group candidate setting unit that selects a person from among persons within a first shot image and sets a first group candidate, based on a spatial condition and a state condition with reference to the selected person; a second group candidate setting unit that selects a person from persons within a second shot image having a different shooting time from the first shot image, using an attribute of the person selected and sets a second group candidate, based on the spatial condition and the state condition; a similarity calculating unit that compares first attribute configuration information about the first group candidate with second attribute configuration information about the second group candidate, and calculates a similarity between the group candidates; and a group specifying unit that specifies the persons constituting the first group candidate as one group according to the similarity.

### TECHNICAL FIELD

The present invention relates to a group specification apparatus and a group specification method that are for specifying a group of persons from shot images, and further relates to a computer-readable recording medium that includes a program recorded thereon for realizing the apparatus and method.

### BACKGROUND ART

Specifying a group (a plurality of persons who interact) from images shot at a public facility or the like and recognizing attributes of the group is useful for improving services and for marketing. Apparatuses for specifying a group based on shot images have thus been proposed heretofore (e.g., see, Patent Documents 1 and 2).

Specifically, an apparatus disclosed in Patent Document 1 specifies a group of persons, by extracting regions of persons from a shot image, and determining whether the persons whose regions were extracted belong to the same group, based on the distance between the extracted regions of the persons and the state of overlap between the regions.

Furthermore, the apparatus disclosed in Patent Document 1 is also able to track the respective regions of the persons extracted from the shot image on a frame-by-frame basis, and, if the distance between the regions of the persons continues to be close, specify the persons in those regions as the same group. In other words, the apparatus disclosed in Patent Document 1 is also able to specify a group, based on the temporal change in the distance between persons.

Also, an apparatus disclosed in Patent Document 2, first, detects persons from a shot image, tracks the detected persons on a frame-by-frame basis, and acquires position information of each person in chronological order. The apparatus disclosed in Patent Document 2 then calculates the relative distance and relative speed of the persons, based on the acquired chronological position information of the persons, and, if a state in which the calculated relative distance and relative speed are within a set range continues for greater than or equal to a given time period, determines that the persons belong to the same group.

### LIST OF RELATED ART DOCUMENTS

### Patent Document

Patent Document 1: Japanese Patent Laid-Open Publication No. 2004-54376
Patent Document 2: Japanese Patent Laid-Open Publication No. 2006-92396

### SUMMARY OF INVENTION

### Problems to be Solved by the Invention

Incidentally, there is a problem with the apparatus disclosed in Patent Document 1 described above in that it is difficult to specify a group in the case where shooting is performed in a crowded environment where persons are close together, or where shooting is performed in a state where the angle of depression of the camera is shallow (i.e., the shooting direction is close to horizontal). This is because when such shooting is performed, persons unrelated to the group are likely to appear together in front of or behind the group in the shot image, and, in determining the distance between the regions of the persons and the state of overlap between the regions, it is difficult to separate out persons who are unrelated to the group.

In response, it is considered possible to resolve the above problem with the apparatus disclosed in Patent Document 1 described above in the case where tracking processing is performed. Similarly, it is considered possible to also resolve the above problem in the case of the apparatus disclosed in Patent Document 2 described above because of tracking processing being performed.

However, there are problems with the tracking processing in that it is difficult to maintain a high tracking accuracy, and also persons who only appear briefly in shot images cannot be tracked. With the apparatus disclosed in Patent Document 1 and the apparatus disclosed in Patent Document 2 described above, groups are specified based on chronological information obtained by the tracking processing, and thus both apparatuses have difficultly specifying a group when such problems occur. It is thus sought to specify groups without relying on tracking persons.

An example object of the present invention is to provide a group specification apparatus, a group specification method, and a computer-readable recording medium that solve the aforementioned problem and specify a group without requiring person tracking processing.

### Means for Solving the Problems

In order to achieve the above-described object, a group specification apparatus for specifying a group from a shot image according to an example aspect of the invention, includes:
a first group candidate setting unit that selects a person from among a plurality of persons within a first shot image, and sets a first group candidate, based on a spatial condition stipulating a position of another person and a state condition stipulating a state of the other person, with reference to the selected person;
a second group candidate setting unit that selects a person from among a plurality of persons within a second shot image having a different shooting time from the first shot image, using an attribute of the person selected by the first group candidate setting unit, and sets a second group candidate, based on the spatial condition and the state condition, with reference to the selected person;
a similarity calculating unit that compares first attribute configuration information including an attribute of each person constituting the first group candidate with second attribute configuration information including an attribute of each person constituting the second group candidate, and calculates a similarity between the first group candidate and the second group candidate; and
a group specifying unit that specifies the persons constituting the first group candidate as one group, if the calculated similarity satisfies a set condition.

In addition, in order to achieve the above-described object, a group specification apparatus for specifying a group from a shot image according to an example aspect of the invention, includes:
a first group candidate setting step of selecting a person from among a plurality of persons within a first shot image, and setting a first group candidate, based on a spatial condition stipulating a position of another person and a state condition stipulating a state of the other person, with reference to the selected person;
a second group candidate setting step of selecting a person from among a plurality of persons within a second shot image having a different shooting time from the first shot image, using an attribute of the person selected at the time of setting the first group candidate, and setting a second group candidate, based on the spatial condition and the state condition, with reference to the selected person;
a similarity calculating step of comparing first attribute configuration information including an attribute of each person constituting the first group candidate with second attribute configuration information including an attribute of each person constituting the second group candidate, and calculating a similarity between the first group candidate and the second group candidate; and
a group specifying step of specifying the persons constituting the first group candidate as one group, if the calculated similarity satisfies a set condition.

Furthermore, in order to achieve the above-described object, a computer readable recording medium according to an example aspect of the invention is a computer readable recording medium that includes recorded thereon a program to cause a computer specify a group from a shot image,
the program including instructions that cause the computer to carry out:
a first group candidate setting step of selecting a person from among a plurality of persons within a first shot image, and setting a first group candidate, based on a spatial condition stipulating a position of another person and a state condition stipulating a state of the other person, with reference to the selected person;
a second group candidate setting step of selecting a person from among a plurality of persons within a second shot image having a different shooting time from the first shot image, using an attribute of the person selected at the time of setting the first group candidate, and setting a second group candidate, based on the spatial condition and the state condition, with reference to the selected person;
a similarity calculating step of comparing first attribute configuration information including an attribute of each person constituting the first group candidate with second attribute configuration information including an attribute of each person constituting the second group candidate, and calculating a similarity between the first group candidate and the second group candidate; and
a group specifying step of specifying the persons constituting the first group candidate as one group, if the calculated similarity satisfies a set condition.

### Advantageous Effects of the Invention

As described above, according to the invention, it is possible to specify a group without requiring person tracking processing.

### BRIEF DESCRIPTION OF THE DRAWINGS

FIG. 1 is a configuration diagram showing a schematic configuration of the group specification apparatus of the example embodiment.

FIG. 2 is a configuration diagram specifically showing the configuration for group specification in the example embodiment.

FIG. 3 is a diagram illustrating a first example of similarity calculation processing in the example embodiment.

FIG. 4 is a diagram illustrating a second example of similarity calculation processing in the example embodiment.

FIG. 5 is a flowchart showing the operations of the group specification apparatus of the example embodiment.

FIG. 6 is a block diagram illustrating an example of a computer that realizes the group specification apparatus according to the example embodiment.

### EXAMPLE EMBODIMENTS

### Example Embodiment

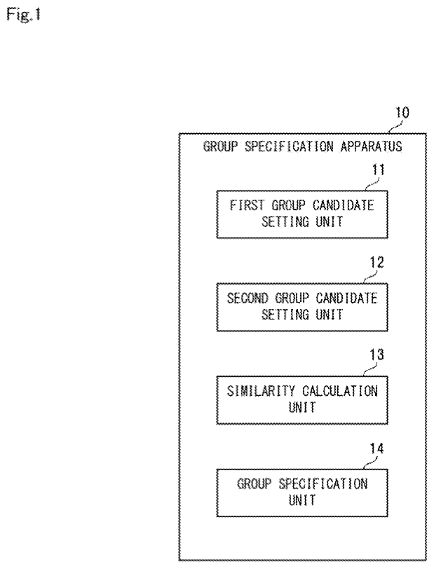

Hereinafter, a group specification apparatus, a group specification method, and a program of the example embodiment will be described using FIGS. 1 to 5.

[Apparatus Configuration]

Initially, a schematic configuration of the group specification apparatus of the example embodiment will be described using FIG. 1. FIG. 1 is a configuration diagram showing a schematic configuration of the group specification apparatus of the example embodiment.

A group specification apparatus 10 of the example embodiment shown in FIG. 1 is an apparatus for specifying a group from shot images. As shown in FIG. 1, the group specification apparatus 10 includes a first group candidate setting unit 11, a second group candidate setting unit 12, a similarity calculation unit 13, and a group specification unit 14.

The first group candidate setting unit 11 selects a person from among a plurality of persons within a first shot image, and sets a first group candidate, based on a spatial condition stipulating the position of another person and a state condition stipulating a state of the other person, with reference to the selected person.

The second group candidate setting unit 12 selects a person from among a plurality of persons within a second shot image having a different shooting time from the first shot image, using attributes of the person selected by the first group candidate setting unit 11. Also, the second group candidate setting unit 12 sets a second group candidate, based on the spatial condition and the state condition, with reference to the selected person.

The similarity calculation unit 13 compares first attribute configuration information that includes the attributes of the persons constituting the first group candidate with second attribute configuration information that includes the attributes of the persons constituting the second group candidate, and calculates the similarity between the first group candidate and the second group candidate.

The group specification unit 14 specifies the persons constituting the first group candidate as one group, if the similarity calculated by the similarity calculation unit 13 satisfies a set condition.

In this way, in the example embodiment, a group candidate is set from each of the two shot images having different shooting date-times, and, furthermore, the similarity between the two set group candidates is calculated. Further, this similarity is used to determine whether persons constituting the group candidates are one group. In other words, according to the example embodiment, a group can be specified without requiring person tracking processing.

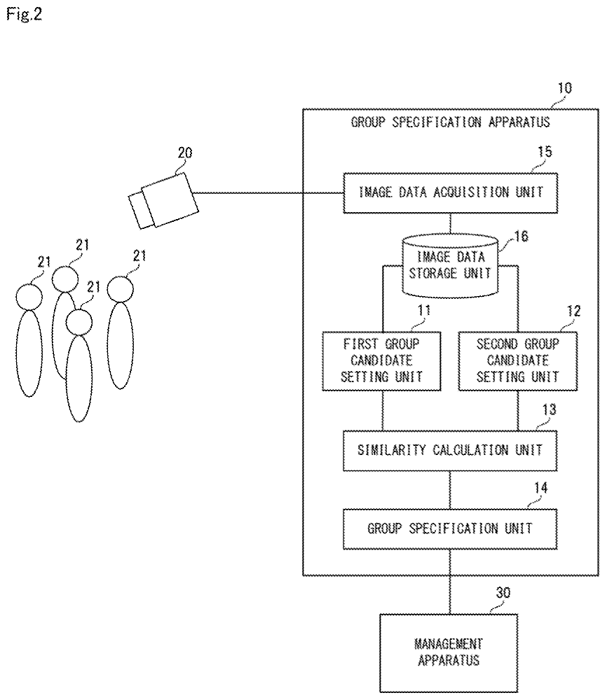

Next, the configuration and function of the group specification apparatus of the example embodiment will be specifically described using FIGS. 2 to 4. FIG. 2 is a configuration diagram specifically showing the configuration for group specification in the example embodiment.

As shown in FIG. 2, in the example embodiment, the group specification apparatus 10 is connected to an image capturing apparatus 20 and a management apparatus 30. The image capturing apparatus 20 is installed in a public facility, for example, and shoots images of a region targeted for shooting at set intervals, and outputs image data of the shot images. In FIG. 2, reference numeral 21 denotes persons who are present in the region targeted for shooting. The management apparatus 30 is specified by the group specification apparatus 10.

Also, as shown in FIG. 2, in the example embodiment, the group specification apparatus 10 includes an image data acquisition unit 15 and an image data storage unit 16, in addition to the first group candidate setting unit 11, the second group candidate setting unit 12, the similarity calculation unit 13, and the group specification unit 14. The image data acquisition unit 15 acquires image data of shot images output from the image capturing apparatus (camera) 20, and stores the acquired image data in the image data storage unit 16 in chronological order.

In the example embodiment, the first group candidate setting unit 11, first, acquires, from the image data storage unit 16, any one of the image data as image data of the first shot image (hereinafter, referred to as “first image data”), detects a plurality of persons from the acquired first image data, and, furthermore, estimates attributes of each of the detected plurality of persons. Note that, in the case where a plurality of persons cannot be detected from the acquired first image data, the first group candidate setting unit 11 acquires different image data as the first image data, and again performs person detection and attribute estimation.

Specifically, the first group candidate setting unit 11 specifies a region in which a person is present from the first image data, using a feature amount representing a person (person's face), and extracts the specified region as a person. The first group candidate setting unit 11 is also able to detect the orientation of a person's face or the orientation of a person (orientation of upper body or lower body) in the person extraction. Next, the first group candidate setting unit 11 obtains a feature amount in the specified region, inputs the obtained feature amount to a classifier, and estimates attributes (gender, age, clothing (color, pattern), height, volume, weight, etc.) of the person in the specified region. The classifier is created in advance, by machine learning the relationship between the attributes and the feature amount.

Next, the first group candidate setting unit 11 selects, as a reference person, any one of the detected plurality of persons. The first group candidate setting unit 11 then sets a first group candidate constituted by the persons detected from the first image data, based on the spatial condition and state condition regarding another person apart from the reference person, with reference to the reference person.

Here, in the example embodiment, the spatial condition includes another person being present within a set range centered on the reference person. The state condition includes another person facing the reference person, another person facing the same direction as the reference person, the size of another person being within a set range referenced on the size of the reference person, and a combination thereof.

In the example embodiment, the second group candidate setting unit 12 acquires, from the image data storage unit 16, image data (hereinafter, referred to as “second image data”) of a plurality of second shot images having different shooting times from the first shot image. Examples of the second shot images include shot images having an earlier shooting time than the shooting time of the first shot image.

The second group candidate setting unit 12 performs, for each of the acquired plurality of second image data, detection of a plurality of persons, and, furthermore, estimation of the attributes of each of the detected plurality of persons. Specifically, the second group candidate setting unit 12, similarly to the first group candidate setting unit 11, specifies a region in which a person is present from each second image data, using a feature amount representing a person (person's face), and extracts the specified region as a person. The second group candidate setting unit 12, similarly to the first group candidate setting unit 11, is also able to detect the orientation of a person's face or the orientation of a person (orientation of upper body or lower body) in the person extraction. Next, the second group candidate setting unit 12, similarly to the first group candidate setting unit 11, obtains a feature amount in the specified region, inputs the obtained feature amount to a classifier, and estimates attributes (gender, age, clothing (color, pattern), height, volume, weight, etc.) of the person in the specified region.

Next, the second group candidate setting unit 12 performs, for each of the plurality of second image data, selection of a person (hereinafter, “corresponding person”) corresponding to the reference person selected by the first group candidate setting unit 11, from among the extracted persons, based on the attributes of the reference person. Note that criteria for judging whether a person is the corresponding person include the number of matching attributes being greater than or equal to a predetermined number and a number of specific attributes being matched.

The second group candidate setting unit 12 then sets a second group candidate constituted by the persons detected from the second image data, based on the spatial condition and state condition regarding another person apart from the corresponding person, with reference to the corresponding person. Note that examples of spatial condition and state condition referred to herein include those illustrated in the description of the first group candidate setting unit 11.

Also, in the example embodiment, the second group candidate setting unit 12 is able to acquire a plurality of second shot images, that is, second image data. In this case, the second group candidate setting unit 12 performs, for each second image data, detection of persons, estimation of attributes, selection of a corresponding person, and setting of a second group candidate.

Furthermore, in the example embodiment, the second group candidate setting unit 12 is also able to set a partial region of the second shot images as a search range, based on the shooting time of the first shot image, the shooting times of the second shot images, and the position of the reference person selected by the first group candidate setting unit 11. In this case, the second group candidate setting unit 12 is able to select a corresponding person from the set search range.

Also, in the example of FIG. 2, the first shot image and the second shot images are output from the same image capturing apparatus 20, but, in the example embodiment, the imaging capturing apparatus that shot the first shot image may be different from the image capturing apparatus that shot the second shot images. In the case where the two imaging capturing apparatuses are different, however, the image capturing apparatuses need to be disposed so as to be able to shoot the same subject within a predetermined time range.

In the example embodiment, the similarity calculation unit 13, first, creates first attribute configuration information that includes the attributes of the persons constituting the first group candidate, using the attributes of the persons that were estimated by the first group candidate setting unit 11. Also, the similarity calculation unit 13 creates second attribute configuration information that includes the attributes of the persons constituting the second group candidate, using the attributes of the persons that were estimated by the second group candidate setting unit 12.

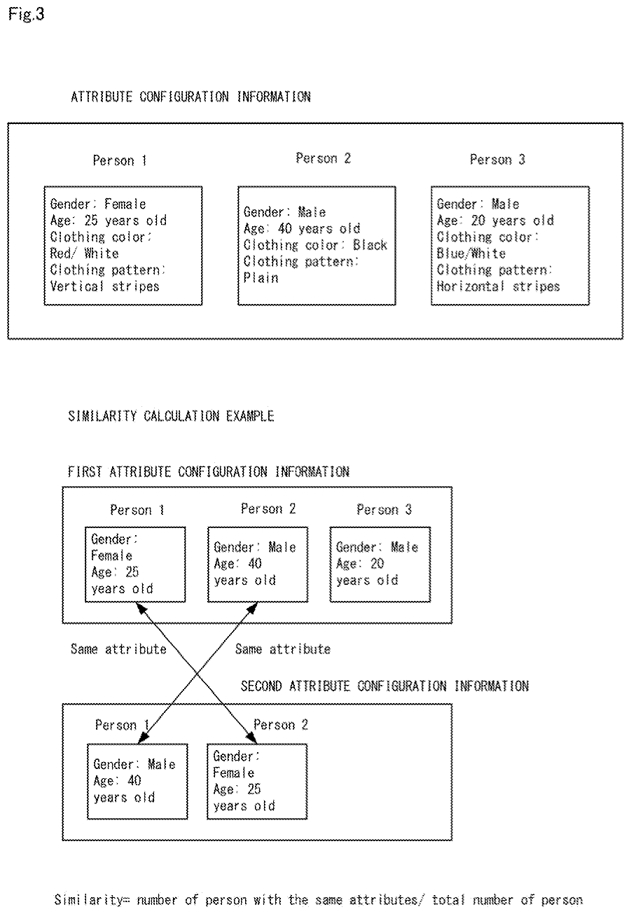

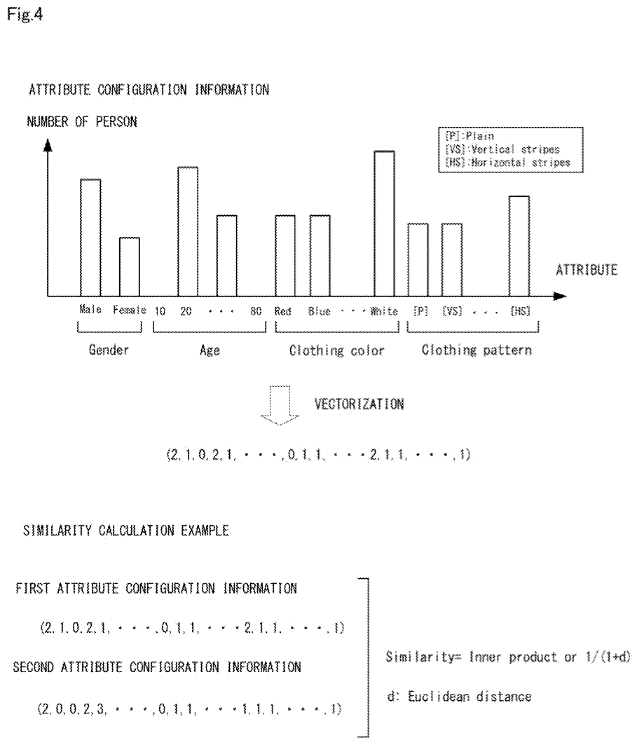

Next, the similarity calculation unit 13 performs, for each of the plurality of second shot images (second image data), comparison of the attributes of the persons that are included in the first attribute configuration information with the attributes of the persons that are included in the second attribute configuration information, and calculation of a similarity, based on the comparison result. Similarity calculation processing will now be described in detail, using FIGS. 3 and 4. FIG. 3 is a diagram illustrating a first example of similarity calculation processing in the example embodiment. FIG. 4 is a diagram illustrating a second example of similarity calculation processing in the example embodiment.

In the example shown in FIG. 3, the first attribute configuration information and the second attribute configuration information are constituted by label data respectively representing the attributes of the persons constituting the group candidates. Further, in the example shown in FIG. 3, the similarity calculation unit 13 calculates, as the similarity, the ratio of persons having the same attributes to the number of all persons in the first group candidate and second group candidate combined.

In the example shown in FIG. 4, the first attribute configuration information and the second attribute configuration information are constituted in a form where each attribute of the persons constituting the group candidates is organized by the number of persons having that attribute. Further, in the example shown in FIG. 4, the similarity calculation unit 13, first, vectorizes the first attribute configuration information and the second attribute configuration information. Next, the similarity calculation unit 13 calculates, as the similarity, an inner product of the vectorized first attribute configuration information and the vectorized second attribute configuration information. The similarity calculation unit 13 is also able to calculate a Euclidean distance d between the vectorized first attribute configuration information and the vectorized second attribute configuration information, and calculate the similarity (=1/(1+d)) from the Euclidean distance d.

In the example embodiment, the group specification unit 14 determines whether the set condition is satisfied, using the similarity calculated for each of the plurality of second shot images (second image data), and, if the set condition is satisfied, specifies the persons constituting the first group candidate as one group. An example of the set condition is the number of second image data having a similarity greater than or equal to a threshold value being greater than or equal to a set number.

Also, the group specification unit 14, in the case of specifying the persons constituting the first group candidate as one group, outputs information relating to the first group candidate specified as one group to the management apparatus 30. The group specification unit 14 is, for example, able to output, as information relating to the first group candidate, at least one of the position, size, orientation, attributes and first attribute configuration information of each person constituting the first group candidate.

Also, a database (hereinafter, referred to as “sample database”) in which a plurality of groups serving as samples (hereinafter, referred to as “sample groups”) and attribute configuration information thereof is registered in advance is assumed to have been prepared. Examples of sample groups include couple, family, travel group, company colleagues, and student group.

In such a mode, the group specification unit 14, in the case of specifying the persons constituting the first group candidate as one group, also specifies a sample group that conforms with the first group candidate by checking the first attribute configuration information of the first group candidate against the database. The group specification unit 14 is able to also output information on the sample group to the management apparatus 30.

Furthermore, the group specification unit 14, in the case where there are a plurality of first group candidates respectively specified as one group, determines whether there are persons common between the plurality of first group candidates respectively specified as one group. The group specification unit 14 is then able to integrate the first group candidates determined to have common persons into one group. According to this mode, more accurate specification of groups is achieved.

[Apparatus Operations]

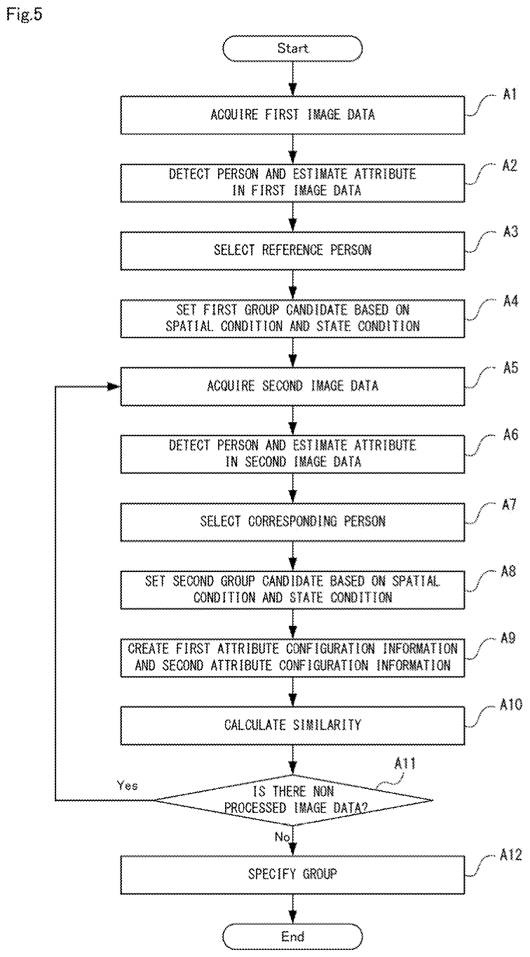

Next, operations of the group specification apparatus of the example embodiment will be described using FIG. 5. FIG. 5 is a flowchart showing the operations of the group specification apparatus of the example embodiment. In the following description, FIGS. 1 to 4 will be referred to as appropriate. Also, in the example embodiment, a group specification method is implemented by operating the group specification apparatus 10. Therefore, the following description of the operations of the group specification apparatus 10 will be given in place of a description of the group specification method of the example embodiment.

Also, first, it is assumed that the image data acquisition unit 15 has acquired image data for a certain period that has been output from the image capturing apparatus (camera) 20, and has stored the acquired image data in the image data storage unit 16 in chronological order.

As shown in FIG. 5, initially, the first group candidate setting unit 11 acquires, from the image data storage unit 16, any one of the image data as first image data (step A1).

Next, the first group candidate setting unit 11 detects a plurality of persons from the first image data acquired in step A1, and, furthermore, estimates attributes of each of the detected plurality of persons (step A2). Note that, in step A2, in the case where a plurality of persons cannot be detected from the first image data, the first group candidate setting unit 11 acquires different image data as the first image data, and again performs person detection and attribute estimation.

Next, the first group candidate setting unit 11 selects any one of the plurality of persons detected in step A2 as a reference person (step A3). The criterion for selecting the reference person is not particularly limited, and a mode where a person is randomly selected or a mode where a person in a predetermined position within the image is selected may be adopted.

Next, the first group candidate setting unit 11 sets a first group candidate constituted by the persons detected from the first image data, based on the spatial condition and state condition regarding another person apart from the reference person, with reference to the reference person selected in step A3 (step A4).

Next, the second group candidate setting unit 12 acquires, from the image data storage unit 16, image data (second image data) of a shot image that was shot earlier than the shooting time of the shot image of the first image data (step A5).

Next, the second group candidate setting unit 12 detects a plurality of persons from the second image data acquired in step A5, and, furthermore, estimates attributes of each of the detected plurality of persons (step A6). Also, in step A6, similarly to step A2, if a plurality of persons cannot be detected from the second image data, the second group candidate setting unit 12 acquires different image data as the second image data and again performs person detection and attribute estimation.

Next, the second group candidate setting unit 12 selects a corresponding person who corresponds to the reference person, from among the persons extracted in step A6, based on the attributes of the reference person selected by the first group candidate setting unit 11 in step A3 (step A7).

Next, the second group candidate setting unit 12 sets a second group candidate constituted by the persons detected from the second image data, based on the spatial condition and state condition regarding another person apart from the corresponding person, with reference to the corresponding person (step A8). Note that the spatial condition and state condition referred to here are the same as the spatial condition and state condition that are used in step A4.

Next, the similarity calculation unit 13 creates first attribute configuration information that includes the attributes of the persons constituting the first group candidate, using the attributes of the persons that were estimated in step A2, and creates second attribute configuration information that includes the attributes of the persons constituting the second group candidate, using the attributes of the persons that were estimated in step A6 (step A9).

Next, the similarity calculation unit 13 compares the attributes of the persons that are included in the first attribute configuration information created in step A9 with the attributes of the persons that are included in the second attribute configuration information likewise created in step A9, and calculates the similarity, based on a result of the comparison (step A10). The similarity calculation is as shown in FIG. 3 or 4.

Next, the similarity calculation unit 13 determines whether there is image data that has not yet been processed as second image data in the image data storage unit 16 (step A11). If the result of the determination in step A11 indicates that there is image data that has not yet been processed in the image data storage unit 16 (step A11: Yes), step A5 is executed again. On the other hand, if the result of the determination in step A11 indicates that there is no image data that has not yet been processed in the image data storage unit 16 (step A11: No), step A12 is executed.

In step A12, the group specification unit 14 determines whether the set condition is satisfied using the similarity calculated for each second image data, and, if the set condition is satisfied, specifies the persons constituting the first group candidate as one group (step A12).

In step A12, the group specification unit 14, furthermore, outputs information (position, size, orientation, attributes, and first attribute configuration information of each person) relating to the first group candidate specified as one group to the management apparatus 30.

Furthermore, in step A12, the group specification unit 14 is able to specify a sample group that conforms with the first group candidate, by checking the first attribute configuration information of the first group candidate against the database, and to also output information on the sample group to the management apparatus 30.

Also, the group specification unit 14, in the case where there are a plurality of first group candidates respectively specified as one group in step A12 executed previously, determines whether there are persons common between the plurality of first group candidates respectively specified as one group. The group specification unit 14 is then able to integrate the first group candidates determined to have common persons into one group.

Also, in step A12, if the group specification unit 14 does not specify the persons constituting the first group candidate as one group, the first group candidate setting unit 11 selects, as the reference person, a person who has not yet been selected, from among the plurality of persons within the first shot image. The first group candidate setting unit 11 then executes step A4 again and newly sets the first group candidate.

When the first group candidate is newly set, the second group candidate setting unit 12 executes steps A7 and A8 again to newly set the second group candidate. Also, when the first group candidate and the second group candidate are newly set, the similarity calculation unit 13 executes steps A9 and A10 again to newly calculate the similarity. Thereafter, the group specification unit 14 executes step A12 again and specifies a group, using the newly calculated similarity.

### Effects of Example Embodiment

As described above, in the example embodiment, a group candidate is set for each image, using a first shot image and second shot image having different shooting times, and the similarity between the set group candidates is obtained. Also, the similarity is obtained between one first shot image and a plurality of second shot images, and a final group is specified from a number of the obtained similarities. Thus, in the example embodiment, even in a crowded environment where persons are close together, or when the angle of depression of the camera is shallow (i.e., the shooting direction is close to the horizontal), a group can be accurately specified, without requiring person tracking processing.

[Program]

It suffices for a program in the example embodiment to be a program that causes a computer to carry out steps A1 to A12 shown in FIG. 5. Also, by this program being installed and executed in the computer, the group specification apparatus 10 and the group specification method according to the example embodiment can be realized. In this case, a processor of the computer functions and performs processing as the first group candidate setting unit 11, the second group candidate setting unit 12, the similarity calculation unit 13, the group specification unit 14, and the image data acquisition unit 15.

In the example embodiment, the image data storage unit 16 may be realized by storing data files consisting it in a storage device such as a hard disk provided in the computer, or may be realized by storing data files consisting it in a storage device of another computer.

The computer includes general-purpose PC, smartphone and tablet-type terminal device. Furthermore, the computer may be a computer that constitutes the management apparatus 30. In this case, the group specification apparatus 10 according to the example embodiment is constructed on the operating system of the management apparatus 30.

Furthermore, the program according to the example embodiment may be executed by a computer system constructed with a plurality of computers. In this case, for example, each computer may function as one of the first group candidate setting unit 11, the second group candidate setting unit 12, the similarity calculation unit 13, the group specification unit 14, and the image data acquisition unit 15.

[Physical Configuration]

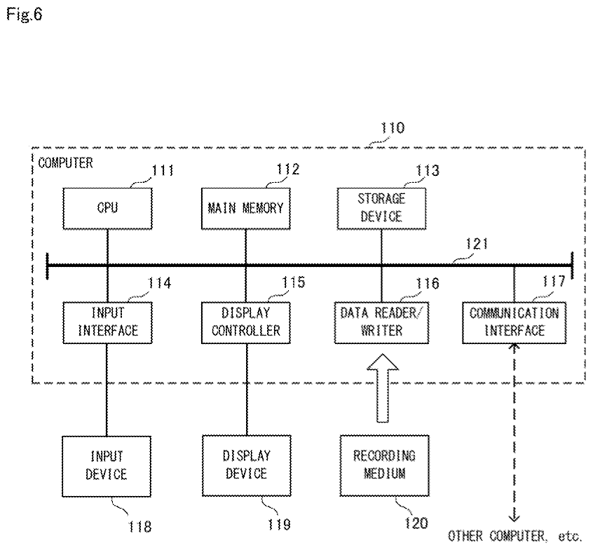

Using FIG. 8, the following describes a computer that realizes the group specification apparatus by executing the program according to the example embodiment. FIG. 6 is a block diagram illustrating an example of a computer that realizes the group specification apparatus according to the example embodiment.

As shown in FIG. 6, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the programs according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the present example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the group specification apparatus 10 according to the example embodiment can also be realized by using items of hardware that respectively correspond to the components, such as a circuit, rather than the computer in which the program is installed. Furthermore, a part of the group specification apparatus 10 according to the example embodiment may be realized by the program, and the remaining part of the group specification apparatus 10 may be realized by hardware.

A part or an entirety of the above-described example embodiment can be represented by (Supplementary Note 1) to (Supplementary Note 39) described below but is not limited to the description below.

(Supplementary Note 1)

A group specification apparatus for specifying a group from a shot image, comprising:
a first group candidate setting unit that selects a person from among a plurality of persons within a first shot image, and sets a first group candidate, based on a spatial condition stipulating a position of another person and a state condition stipulating a state of the other person, with reference to the selected person;
a second group candidate setting unit that selects a person from among a plurality of persons within a second shot image having a different shooting time from the first shot image, using an attribute of the person selected by the first group candidate setting unit, and sets a second group candidate, based on the spatial condition and the state condition, with reference to the selected person;
a similarity calculating unit that compares first attribute configuration information including an attribute of each person constituting the first group candidate with second attribute configuration information including an attribute of each person constituting the second group candidate, and calculates a similarity between the first group candidate and the second group candidate; and
a group specifying unit that specifies the persons constituting the first group candidate as one group, if the calculated similarity satisfies a set condition.

(Supplementary Note 2)

The group specification apparatus according to Supplementary Note 1,
wherein the second group candidate setting unit sets the second group candidate, for each of a plurality of second shot images having different shooting times,
the similarity calculating unit performs, for each of the plurality of second shot images, comparison of the attributes of the persons constituting the first group candidate that are included in the first attribute configuration information with the attributes of the persons constituting the second group candidate that are included in the second attribute configuration information, and calculation of the similarity, and
the group specifying unit determines whether the set condition is satisfied, using the similarity calculated for each of the plurality of second shot images, and, if the set condition is satisfied, specifies the persons constituting the first group candidate as one group.

(Supplementary Note 3)

The group specification apparatus according to Supplementary Note 1 or 2,
wherein the spatial condition includes the other person being present within a set range centered on the selected person, and
the state condition includes the other person facing the selected person or facing a same direction as the selected person.

(Supplementary Note 4)

The group specification apparatus according to Supplementary Note 3,
wherein the state condition further includes a size of the other person being within a set range referenced on a size of the selected person.

(Supplementary Note 5)

The group specification apparatus according to any one of Supplementary Notes 1 to 4,
wherein the first attribute configuration information is constituted by label data respectively representing the attributes of the persons constituting the first group candidate,
the second attribute configuration information is constituted by label data respectively representing the attributes of the persons constituting the second group candidate, and
the similarity calculating unit calculates, as the similarity, a ratio of persons having same attributes to a number of all persons in the first group candidate and second group candidate combined.

(Supplementary Note 6)

The group specification apparatus according to any one of Supplementary Notes 1 to 4,
wherein the first attribute configuration information is constituted in a form where each attribute of the persons constituting the first group candidate is organized by the number of persons having the attribute,
the second attribute configuration information is constituted in a form where each attribute of the persons constituting the second group candidate is organized by the number of persons having the attribute, and
the similarity calculating unit calculates, as the similarity, an inner product of the first attribute configuration information and the second attribute configuration information, or a Euclidean distance therebetween.

(Supplementary Note 7)

The group specification apparatus according to any one of Supplementary Notes 1 to 6,
wherein, the group specifying unit, in a case of specifying the persons constituting the first group candidate as one group, outputs at least one of a position, size, orientation, attribute and the first attribute configuration information of each person constituting the first group candidate.

(Supplementary Note 8)

The group specification apparatus according to any one of Supplementary Notes 1 to 7,
wherein the shooting time of the second shot image is earlier than the shooting time of the first shot image, and
the first shot image and the second shot image are shot by the same image capturing apparatus.

(Supplementary Note 9)

The group specification apparatus according to any one of Supplementary Notes 1 to 7,
wherein the first shot image and the second shot image are shot by different image capturing apparatuses, and
the image capturing apparatus that shot the first shot image and the image capturing apparatus that shot the second shot image are disposed so as to be able to shoot a same subject within a predetermined time range.

(Supplementary Note 10)

The group specification apparatus according to any one of Supplementary Notes 1 to 9,
wherein the second group candidate setting unit sets a partial region of the second shot image as a search range, based on the shooting time of the first shot image, the shooting time of
the second shot image, and the position of the person selected by the first group candidate setting unit, and selects a person from the set search range.

(Supplementary Note 11)

The group specification apparatus according to any one of Supplementary Notes 1 to 10,
wherein, the group specifying unit, in a case of specifying the persons constituting the first group candidate as one group, specifies a group serving as a sample that conforms with the first group candidate, by checking the first attribute configuration information of the first group candidate against a database in which a plurality of groups serving as samples and attribute configuration information thereof are registered in advance.

(Supplementary Note 12)

The group specification apparatus according to any one of Supplementary Notes 1 to 11,
wherein, the group specifying unit, in a case where there are a plurality of first group candidates respectively specified as one group, determines whether there are persons common between the plurality of first group candidates respectively specified as one group, and integrates first group candidates determined to have common persons into one group.

(Supplementary Note 13)

The group specification apparatus according to any one of Supplementary Notes 1 to 12,
wherein, in a case where the group specifying unit does not specify the persons constituting the first group candidate as one group, the first group candidate setting unit newly selects a person who has not yet been selected, from among the plurality of persons within the first shot image, and newly sets the first group candidate,
the second group candidate setting unit newly sets the second group candidate when the first group candidate is newly set,
the similarity calculating unit newly calculates the similarity when the first group candidate and the second group candidate are newly set, and
the group specifying unit specifies a group, using the newly calculated similarity.

(Supplementary Note 14)

A group specification method for specifying a group from a shot image, comprising:
a first group candidate setting step of selecting a person from among a plurality of persons within a first shot image, and setting a first group candidate, based on a spatial condition stipulating a position of another person and a state condition stipulating a state of the other person, with reference to the selected person;
a second group candidate setting step of selecting a person from among a plurality of persons within a second shot image having a different shooting time from the first shot image, using an attribute of the person selected at the time of setting the first group candidate, and setting a second group candidate, based on the spatial condition and the state condition, with reference to the selected person;
a similarity calculating step of comparing first attribute configuration information including an attribute of each person constituting the first group candidate with second attribute configuration information including an attribute of each person constituting the second group candidate, and calculating a similarity between the first group candidate and the second group candidate; and
a group specifying step of specifying the persons constituting the first group candidate as one group, if the calculated similarity satisfies a set condition.

(Supplementary Note 15)

The group specification method according to Supplementary Note 14,
Wherein, in the second group candidate setting step, setting the second group candidate, for each of a plurality of second shot images having different shooting times,
in the similarity calculating step, performing, for each of the plurality of second shot images, comparison of the attributes of the persons constituting the first group candidate that are included in the first attribute configuration information with the attributes of the persons constituting the second group candidate that are included in the second attribute configuration information, and calculation of the similarity, and
in the group specifying step, determining whether the set condition is satisfied, using the similarity calculated for each of the plurality of second shot images, and, if the set condition is satisfied, specifying the persons constituting the first group candidate as one group.

(Supplementary Note 16)

The group specification method according to Supplementary Note 14 or 15,
wherein the spatial condition includes the other person being present within a set range centered on the selected person, and
the state condition includes the other person facing the selected person or facing a same direction as the selected person.

(Supplementary Note 17)

The group specification method according to Supplementary Note 16,
wherein the state condition further includes a size of the other person being within a set range referenced on a size of the selected person.

(Supplementary Note 18)

The group specification method according to any one of Supplementary Notes 14 to 17,
wherein the first attribute configuration information is constituted by label data respectively representing the attributes of the persons constituting the first group candidate,
the second attribute configuration information is constituted by label data respectively representing the attributes of the persons constituting the second group candidate, and
in the similarity calculating step, calculating, as the similarity, a ratio of persons having same attributes to a number of all persons in the first group candidate and second group candidate combined.

(Supplementary Note 19)

The group specification method according to any one of Supplementary Notes 14 to 17,
wherein the first attribute configuration information is constituted in a form where each attribute of the persons constituting the first group candidate is organized by the number of persons having the attribute,
the second attribute configuration information is constituted in a form where each attribute of the persons constituting the second group candidate is organized by the number of persons having the attribute, and
in the similarity calculating step, calculating, as the similarity, an inner product of the first attribute configuration information and the second attribute configuration information, or a Euclidean distance therebetween.

(Supplementary Note 20)

The group specification method according to any one of Supplementary Notes 14 to 19,
wherein, in the group specifying step, in a case of specifying the persons constituting the first group candidate as one group, outputting at least one of a position, size, orientation, attribute and the first attribute configuration information of each person constituting the first group candidate.

(Supplementary Note 21)

The group specification method according to any one of Supplementary Notes 14 to 20,
wherein the shooting time of the second shot image is earlier than the shooting time of the first shot image, and
the first shot image and the second shot image are shot by the same image capturing apparatus.

(Supplementary Note 22)

The group specification method according to any one of Supplementary Notes 14 to 20,
wherein the first shot image and the second shot image are shot by different image capturing apparatuses, and
the image capturing apparatus that shot the first shot image and the image capturing apparatus that shot the second shot image are disposed so as to be able to shoot a same subject within a predetermined time range.

(Supplementary Note 23)

The group specification method according to any one of Supplementary Notes 14 to 22,
wherein, in the second group candidate setting step, setting a partial region of the second shot image as a search range, based on the shooting time of the first shot image, the shooting time of the second shot image, and the position of the person selected by the first group candidate setting unit, and selecting a person from the set search range.

(Supplementary Note 24)

The group specification method according to any one of Supplementary Notes 14 to 23,
wherein, in the group specifying step, in a case of specifying the persons constituting the first group candidate as one group, specifying a group serving as a sample that conforms with the first group candidate, by checking the first attribute configuration information of the first group candidate against a database in which a plurality of groups serving as samples and attribute configuration information thereof are registered in advance.

(Supplementary Note 25)

The group specification method according to any one of Supplementary Notes 14 to 24,
wherein, in the group specifying step, in a case where there are a plurality of first group candidates respectively specified as one group, determining whether there are persons common between the plurality of first group candidates respectively specified as one group, and integrating first group candidates determined to have common persons into one group.

(Supplementary Note 26)

The group specification method according to any one of Supplementary Notes 14 to 25,
wherein, in the group specifying step, in a case of not specifying the persons constituting the first group candidate as one group, newly selecting a person who has not yet been selected, from among the plurality of persons within the first shot image, and newly setting the first group candidate,
in the second group candidate setting step, newly setting the second group candidate when the first group candidate is newly set,
in the similarity calculating step, newly calculating the similarity when the first group candidate and the second group candidate are newly set, and
in the group specifying step, specifying a group, using the newly calculated similarity.

(Supplementary Note 27)

A computer-readable recording medium that includes a program recorded thereon for specifying a group from a shot image by a computer, the program including instructions that cause the computer to carry out:
a first group candidate setting step of selecting a person from among a plurality of persons within a first shot image, and setting a first group candidate, based on a spatial condition stipulating a position of another person and a state condition stipulating a state of the other person, with reference to the selected person;
a second group candidate setting step of selecting a person from among a plurality of persons within a second shot image having a different shooting time from the first shot image, using an attribute of the person selected at the time of setting the first group candidate, and setting a second group candidate, based on the spatial condition and the state condition, with reference to the selected person;
a similarity calculating step of comparing first attribute configuration information including an attribute of each person constituting the first group candidate with second attribute configuration information including an attribute of each person constituting the second group candidate, and calculating a similarity between the first group candidate and the second group candidate; and
a group specifying step of specifying the persons constituting the first group candidate as one group, if the calculated similarity satisfies a set condition.

(Supplementary Note 28)

The computer-readable recording medium according to Supplementary Note 27,
Wherein, in the second group candidate setting step, setting the second group candidate, for each of a plurality of second shot images having different shooting times,
in the similarity calculating step, performing, for each of the plurality of second shot images, comparison of the attributes of the persons constituting the first group candidate that are included in the first attribute configuration information with the attributes of the persons constituting the second group candidate that are included in the second attribute configuration information, and calculation of the similarity, and
in the group specifying step, determining whether the set condition is satisfied, using the similarity calculated for each of the plurality of second shot images, and, if the set condition is satisfied, specifying the persons constituting the first group candidate as one group.

(Supplementary Note 29)

The computer-readable recording medium according to Supplementary Note 27 or 28,
wherein the spatial condition includes the other person being present within a set range centered on the selected person, and
the state condition includes the other person facing the selected person or facing a same direction as the selected person.

(Supplementary Note 30)

The computer-readable recording medium according to Supplementary Note 29,
wherein the state condition further includes a size of the other person being within a set range referenced on a size of the selected person.

(Supplementary Note 31)

The computer-readable recording medium according to any one of Supplementary Notes 27 to 30,
wherein the first attribute configuration information is constituted by label data respectively representing the attributes of the persons constituting the first group candidate,
the second attribute configuration information is constituted by label data respectively representing the attributes of the persons constituting the second group candidate, and
in the similarity calculating step, calculating, as the similarity, a ratio of persons having same attributes to a number of all persons in the first group candidate and second group candidate combined.

(Supplementary Note 32)

The computer-readable recording medium according to any one of Supplementary Notes 27 to 30,
wherein the first attribute configuration information is constituted in a form where each attribute of the persons constituting the first group candidate is organized by the number of persons having the attribute,
the second attribute configuration information is constituted in a form where each attribute of the persons constituting the second group candidate is organized by the number of persons having the attribute, and
in the similarity calculating step, calculating, as the similarity, an inner product of the first attribute configuration information and the second attribute configuration information, or a Euclidean distance therebetween.

(Supplementary Note 33)

The computer-readable recording medium according to any one of Supplementary Notes 27 to 32,
wherein, in the group specifying step, in a case of specifying the persons constituting the first group candidate as one group, outputting at least one of a position, size, orientation, attribute and the first attribute configuration information of each person constituting the first group candidate.

(Supplementary Note 34)

The computer-readable recording medium according to any one of Supplementary Notes 27 to 33,
wherein the shooting time of the second shot image is earlier than the shooting time of the first shot image, and
the first shot image and the second shot image are shot by the same image capturing apparatus.

(Supplementary Note 35)

The computer-readable recording medium according to any one of Supplementary Notes 27 to 33,
wherein the first shot image and the second shot image are shot by different image capturing apparatuses, and
the image capturing apparatus that shot the first shot image and the image capturing apparatus that shot the second shot image are disposed so as to be able to shoot a same subject within a predetermined time range.

(Supplementary Note 36)

The computer-readable recording medium according to any one of Supplementary Notes 27 to 35,
wherein, in the second group candidate setting step, setting a partial region of the second shot image as a search range, based on the shooting time of the first shot image, the shooting time of the second shot image, and the position of the person selected by the first group candidate setting unit, and selecting a person from the set search range.

(Supplementary Note 37)

The computer-readable recording medium according to any one of Supplementary Notes 27 to 36,
wherein, in the group specifying step, in a case of specifying the persons constituting the first group candidate as one group, specifying a group serving as a sample that conforms with the first group candidate, by checking the first attribute configuration information of the first group candidate against a database in which a plurality of groups serving as samples and attribute configuration information thereof are registered in advance.

(Supplementary Note 38)

The computer-readable recording medium according to any one of Supplementary Notes 27 to 37,
wherein, in the group specifying step, in a case where there are a plurality of first group candidates respectively specified as one group, determining whether there are persons common between the plurality of first group candidates respectively specified as one group, and integrating first group candidates determined to have common persons into one group.

(Supplementary Note 39)

The computer-readable recording medium according to any one of Supplementary Notes 27 to 38,
wherein, in the group specifying step, in a case of not specifying the persons constituting the first group candidate as one group, newly selecting a person who has not yet been selected, from among the plurality of persons within the first shot image, and newly setting the first group candidate,
in the second group candidate setting step, newly setting the second group candidate when the first group candidate is newly set,
in the similarity calculating step, newly calculating the similarity when the first group candidate and the second group candidate are newly set, and
in the group specifying step, specifying a group, using the newly calculated similarity.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the invention, it is possible to specify a group without requiring person tracking processing. The invention is useful in various fields which it is required to identify groups from images.

### REFERENCE SIGNS LIST

10 Group specification apparatus
11 First group candidate setting unit
12 Second group candidate setting unit
13 Similarity calculation unit
14 Group specification unit
15 Image data acquisition unit
16 Image data storage unit
20 Image capturing apparatus
30 Management apparatus
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A group specification apparatus for specifying a group from a shot image, comprising:
at least one memory storing instructions; and
at least one processor configured to execute the instructions to:
select a person from among a plurality of persons within a first shot image, and set a first group candidate, based on a spatial condition stipulating a position of another person and a state condition stipulating a state of the other person, with reference to the selected person;
select a person from among a plurality of persons within a second shot image having a different shooting time from the first shot image, using an attribute of the person selected by the first group candidate setting means, and set a second group candidate, based on the spatial condition and the state condition, with reference to the selected person;
compare first attribute configuration information including an attribute of each person constituting the first group candidate with second attribute configuration information including an attribute of each person constituting the second group candidate, and calculate a similarity between the first group candidate and the second group candidate; and
specify the persons constituting the first group candidate as one group, if the calculated similarity satisfies a set condition.

2. The group specification apparatus according to claim 1,
wherein,
further at least one processor configured to execute the instructions to:
set the second group candidate, for each of a plurality of second shot images having different shooting times,
perform for each of the plurality of second shot images, comparison of the attributes of the persons constituting the first group candidate that are included in the first attribute configuration information with the attributes of the persons constituting the second group candidate that are included in the second attribute configuration information, and calculation of the similarity, and
determine whether the set condition is satisfied, using the similarity calculated for each of the plurality of second shot images, and, if the set condition is satisfied, specify the persons constituting the first group candidate as one group.

3. The group specification apparatus according to claim 1,
wherein the spatial condition includes the other person being present within a set range centered on the selected person, and
the state condition includes the other person facing the selected person or facing a same direction as the selected person.

4. The group specification apparatus according to claim 3,
wherein the state condition further includes a size of the other person being within a set range referenced on a size of the selected person.

5. The group specification apparatus according to claim 1,
wherein the first attribute configuration information is constituted by label data respectively representing the attributes of the persons constituting the first group candidate,
the second attribute configuration information is constituted by label data respectively representing the attributes of the persons constituting the second group candidate, and
further at least one processor configured to execute the instructions to:
calculate, as the similarity, a ratio of persons having same attributes to a number of all persons in the first group candidate and second group candidate combined.

6. The group specification apparatus according to claim 1,
wherein the first attribute configuration information is constituted in a form where each attribute of the persons constituting the first group candidate is organized by the number of persons having the attribute,
the second attribute configuration information is constituted in a form where each attribute of the persons constituting the second group candidate is organized by the number of persons having the attribute, and
further at least one processor configured to execute the instructions to:
calculate, as the similarity, an inner product of the first attribute configuration information and the second attribute configuration information, or a Euclidean distance therebetween.

7. The group specification apparatus according to claim 1,
wherein,
further at least one processor configured to execute the instructions to:
in a case of specifying the persons constituting the first group candidate as one group, output at least one of a position, size, orientation, attribute and the first attribute configuration information of each person constituting the first group candidate.

8. The group specification apparatus according to claim 1,
wherein the shooting time of the second shot image is earlier than the shooting time of the first shot image, and
the first shot image and the second shot image are shot by the same image capturing apparatus.

9. The group specification apparatus according to claim 1,
wherein the first shot image and the second shot image are shot by different image capturing apparatuses, and
the image capturing apparatus that shot the first shot image and the image capturing apparatus that shot the second shot image are disposed so as to be able to shoot a same subject within a predetermined time range.

10. The group specification apparatus according to claim 1,
wherein,
further at least one processor configured to execute the instructions to:
set a partial region of the second shot image as a search range, based on the shooting time of the first shot image, the shooting time of the second shot image, and the position of the person selected by the first group candidate setting means, and select a person from the set search range.

11. The group specification apparatus according to claim 1,
wherein,
further at least one processor configured to execute the instructions to:
in a case of specifying the persons constituting the first group candidate as one group, specify a group serving as a sample that conforms with the first group candidate, by checking the first attribute configuration information of the first group candidate against a database in which a plurality of groups serving as samples and attribute configuration information thereof are registered in advance.

12. The group specification apparatus according to claim 1,
wherein,
further at least one processor configured to execute the instructions to:
in a case where there are a plurality of first group candidates respectively specified as one group, determine whether there are persons common between the plurality of first group candidates respectively specified as one group, and integrate first group candidates determined to have common persons into one group.

13. The group specification apparatus according to claim 1,
wherein,
further at least one processor configured to execute the instructions to:
in a case where the group specifying means does not specify the persons constituting the first group candidate as one group, newly select a person who has not yet been selected, from among the plurality of persons within the first shot image, and newly sets the first group candidate,
newly set the second group candidate when the first group candidate is newly set,
newly calculate the similarity when the first group candidate and the second group candidate are newly set, and
specify a group, using the newly calculated similarity.

14. A group specification method for specifying a group from a shot image, comprising:
selecting a person from among a plurality of persons within a first shot image, and setting a first group candidate, based on a spatial condition stipulating a position of another person and a state condition stipulating a state of the other person, with reference to the selected person;
selecting a person from among a plurality of persons within a second shot image having a different shooting time from the first shot image, using an attribute of the person selected at the time of setting the first group candidate, and setting a second group candidate, based on the spatial condition and the state condition, with reference to the selected person;
comparing first attribute configuration information including an attribute of each person constituting the first group candidate with second attribute configuration information including an attribute of each person constituting the second group candidate, and calculating a similarity between the first group candidate and the second group candidate; and
specifying the persons constituting the first group candidate as one group, if the calculated similarity satisfies a set condition.

15. A non-transitory computer-readable recording medium that includes a program recorded thereon for specifying a group from a shot image by a computer, the program including instructions that cause the computer to carry out:
selecting a person from among a plurality of persons within a first shot image, and setting a first group candidate, based on a spatial condition stipulating a position of another person and a state condition stipulating a state of the other person, with reference to the selected person;
selecting a person from among a plurality of persons within a second shot image having a different shooting time from the first shot image, using an attribute of the person selected at the time of setting the first group candidate, and setting a second group candidate, based on the spatial condition and the state condition, with reference to the selected person;
comparing first attribute configuration information including an attribute of each person constituting the first group candidate with second attribute configuration information including an attribute of each person constituting the second group candidate, and calculating a similarity between the first group candidate and the second group candidate; and
specifying the persons constituting the first group candidate as one group, if the calculated similarity satisfies a set condition.
